(19) United States
(12) Patent Application Publication
(10) Pub. No.: US 2013/0124151 A1
(43) Pub. Date: May 16, 2013

(54) Methods and Apparatus for Printability of Three-Dimensional Objects

(71) Applicants: Radomir Mech, Mountain View, CA (US); Nathan A. Carr, San Jose, CA (US); Ondrej Stava, Battle Ground, IN (US)

(72) Inventors: Radomir Mech, Mountain View, CA (US); Nathan A. Carr, San Jose, CA (US); Ondrej Stava, Battle Ground, IN (US)

(21) Appl. No.: 13/408,890

(22) Filed: Feb. 29, 2012

Related U.S. Application Data
(60) Provisional application No. 61/528,017, filed on Aug. 26, 2011.

(51) Int. Cl. G06F 17/50

(52) U.S. Cl. 703/1

(57) ABSTRACT

Methods and apparatus for improving printability of a three-dimensional model are disclosed. For a computer-based three-dimensional model to be generated by a three-dimensional printing system, a three-dimensional printability analysis of the model is performed. The three-dimensional printability analysis applies one or more test cases representing forces that may be applied to the model. The three-dimensional printability analysis generates one or more points at which stresses associated with the test case exceed the structural tolerances of a material to be used by the three-dimensional printing system for a fabrication of the model. For each point of the one or more points, one or more corrections to the model designed to decrease the stresses associated with a respective test case are calculated. For each test case, the corrections are evaluated. The evaluating includes selecting a preferred correction based on one or more criteria.

This application claims benefit of priority of U.S. Provisional Application Ser. No. 61/528,017 entitled “Methods and Apparatus for Visual Search” filed Aug. 26, 2011, the content of which is incorporated by reference herein in its entirety.

### BACKGROUND

### Description of the Related Art

Three dimensional printing is a convenient method for transferring computer generated models into the real world. Advancements in three dimensional printing technology provide an option for printing objects with high precision using various materials for a price that is affordable to a wide range of potential users.

The increasing popularity of 3D printing also introduces many new problems and challenges. Often, when models are printed by a vendor and shipped to users, users discover that the model they specified for printing arrived broken or damaged.

Even when a design is not visibly deficient as displayed in a computer-aided-design platform on a computer, the object that is a real-world representation of the design may prove too brittle for manual handling or it might collapse from the effects of gravity. Many casual users are unable or unwilling to alter their computer models into a state in which they can be safely printed.

### SUMMARY

Various embodiments of methods and apparatus for improving printability of a three-dimensional model are disclosed. For a computer-based three-dimensional model to be generated by a three-dimensional printing system, a three-dimensional printability analysis of the model is performed. The three-dimensional printability analysis applies one or more test cases representing forces that may be applied to the model. The three-dimensional printability analysis generates one or more points at which stresses associated with the test case exceed the structural tolerances of a material to be used by the three-dimensional printing system for a fabrication of the model. For each point of the one or more points, one or more corrections to the model designed to decrease the stresses associated with a respective test case are calculated. For each test case, the corrections are evaluated. The evaluating includes selecting a preferred correction based on one or more criteria.

### BRIEF DESCRIPTION OF THE DRAWINGS

FIG. 1 illustrates a module that may implement improvement of printability of three-dimensional objects, according to some embodiments.

FIG. 2 depicts one embodiment of a high-level logical flowchart for a process to improve printability of three-dimensional objects.

FIG. 3 illustrates a high-level logical flowchart for a hollowing operation to improve printability of three-dimensional objects, according to some embodiments.

FIG. 4A depicts a high-level logical flowchart for a static test case detection operation to improve printability of three-dimensional objects, according to some embodiments.

FIG. 4B illustrates a high-level logical flowchart for a dynamic test case detection operation to improve printability of three-dimensional objects, according to some embodiments.

FIG. 5 depicts a high-level logical flowchart for a correction operation to improve printability of three-dimensional objects, according to some embodiments.

FIG. 6A illustrates one embodiment of a high-level logical flowchart for a process to improve printability of three-dimensional objects.

FIG. 6B depicts one embodiment of a high-level logical flowchart for a process to improve printability of three-dimensional objects.

FIG. 6C illustrates one embodiment of a high-level logical flowchart for a process to improve printability of three-dimensional objects.

FIG. 7 depicts a high-level logical flowchart for a correction calculation operation to improve printability of three-dimensional objects, according to some embodiments.

FIG. 8 illustrates a high-level logical flowchart for a correction analysis operation to improve printability of three-dimensional objects, according to some embodiments.

FIG. 9A depicts a model of a solid object that may be improved using a process to improve printability of three-dimensional objects, according to some embodiments.

FIG. 9B illustrates a result of a stress analysis of a model of a solid object for use in a process to improve printability of three-dimensional objects, according to some embodiments.

FIG. 9C depicts an improved model of a solid object resulting from a process to improve printability of three-dimensional objects, according to some embodiments.

FIGS. 9D-9F illustrate test cases for a stress analysis of a model of a solid object for use in a process to improve printability of three-dimensional objects, according to some embodiments.

FIG. 10 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Introduction to Printability of Three-Dimensional Objects

Embodiments provide methods and systems for automatic detection and correction of printability problems in 3D printing. Some embodiments identify problems caused by factors such as gravity and manual user manipulation of the printed object. Using some embodiments, detected problems can be automatically eliminated using three different model correction techniques. Examples include hollowing, local thickening, and adding of supporting struts. As one of ordinary skill in the art will readily understand after having read the present disclosure, the examples presented herein are limited for the purpose of brevity, and other model correction techniques may be used by embodiments without deviating from the scope and intent of the present disclosure.

Some embodiments include a printability assessment based on structural analysis of an input model and provide automatic model correction through multiple structural refinement techniques. For example, some embodiments automatically reduce the weight of the model by performing hollowing, as discussed below. Additionally, some embodiments fix problematic thin parts using local thickening, as also discussed below. Further, some embodiments reinforce parts of the model subjected to significant deformations by using an automatic strut placement algorithm, as discussed below. As one of ordinary skill in the art will readily understand after having read the present disclosure, the examples presented herein are limited for the purpose of brevity, and other model correction techniques may be used by embodiments without deviating from the scope and intent of the present disclosure.

Some embodiments perform an optional hollowing step to remove material from the interior of the thick components of the input model. Such embodiments may reduce stress to the model caused by gravity and may also lower the cost of the printed object as the price of three-dimensional printing is sometimes determined by the volume or mass of the printed material. In some embodiments, thick components of the model are obtained as a result of thickness segmentation of the volume of the input mesh. In some embodiments, a medial axis-based method is used to approximate the local thickness everywhere inside the mesh.

In some embodiments, hollowing of a model provides cost reduction without significantly altering the exterior shape of the model. In some embodiments, hollowing can be used to reduce stress from models where the thick parts are pulled down because of gravity while being supported by thinner parts that cannot hold the weight. In some embodiments, different model correction techniques are used for cases in which the input model does not contain a significant amount of thick components, or when the printability problems are caused by other external factors like manual handling of the printed object. To detect and correct these printability problems, some embodiments first identify and simulate the external forces. While a printed object can be handled in various ways that lead into an infinite number of cases for simulation, some embodiments simplify the problem by computing only a limited set of test cases that are intended to represent the most common external conditions.

In some embodiments, test cases are divided into two groups. Such embodiments detect so-called “still” or “static” test cases that represent situations in which the object is standing or lying on a flat surface without any human interaction. In such cases, case the object is subject only to gravitational forces and its movement is controlled by the planar surface. To find a set of still test cases, such embodiments first compute the convex hull of the object, which helps such embodiments to identify the most probable directions in which the object can be placed on a plane. A stability of each position is determined using a center of mass of the object that lies above the contact area of the convex hull.

Another group of test cases are so-called “dynamic” test cases. Some embodiments identify probable descriptions of forces representing situations in which the object is being manipulated by a person. Some embodiments limit such dynamic test cases to cases in which the object is being held by a handle. As used herein, a handle can be any part that can be held by one hand and that is accessible to the users. To find handles, some embodiments analyze the topology of the thin and thick components of the model, looking for thin parts that are close to the exterior of the object. Because not all handles are reasonable, some embodiments filter the results and remove handles whose shape is less probable for being used when holding the object. Specifically, some embodiments remove handles that are either too thin themselves or are directly connected to another thin part of the object.

Some embodiments then perform a structural analysis for each of the test cases and use the results to test whether the stress in the object is too high, (e.g., calculated stress exceeding a threshold at which the printed model might exhibit a high probability of breakage). If the stress in the model is below a given threshold value, some embodiments send the model to a 3D printer. In cases in which the stress is too high, some embodiments automatically fix problematic parts of the model, as discussed below. Some embodiments reduce the stress directly by performing local thickening of the thin components of the model on areas where the stress level is too high. Alternatively, some embodiments lower the stress indirectly by adding new supporting struts that are intended to reduce deformations between two parts on the model. In some embodiments, a medial axis external to the object is used to guide placement of the struts. In one embodiment, an exterior medial axis can be computed and used to detect concave regions that are candidate locations for adding struts. Each location on the exterior medial axis provides a set of corresponding surface locations that can be connected together with a strut. Additionally, it is possible to reduce stress by performing a hollowing step, previously described.

Choice of corrections is, in some embodiments, based on a set of parameters used to compute the cost of every possible correction and choose a correction with the lowest cost. After the model is fixed using the selected correction(s), structural analysis is iterated with the corrections included.

The presented methods and systems for the three-dimensional model analysis and correction are general in nature and embodiments are not limited to a specific three-dimensional printer or material. Some embodiments execute as cloud services, while others are implemented on desktop machines. In some cloud embodiments, users upload models with specified material properties to a server and results are returned. Such results may include a set of corrected models that can be safely printed. In some embodiments, the users then choose which model to use for the printing.

Some embodiments may include a means for improving printability of three-dimensional objects. For example, a model stress relief module may receive input identifying a model of a three-dimensional object to be generated by a three dimensional printing system and may perform a three-dimensional printability analysis of the model. In some embodiments, the three-dimensional printability analysis applies one or more test cases representing forces that may be applied to the model. In some embodiments, the three-dimensional printability analysis generates one or more points at which stresses associated with a test case exceed the structural tolerances of a material to be used by the three-dimensional printing system for a fabrication of the model. The model stress relief module may calculate one or more corrections to the model designed to decrease the stresses associated with a respective test case. The model stress relief module may evaluate the corrections, including, in some embodiments selecting a preferred correction based on one or more criteria.

The model stress relief module or other apparatus or system for improving printability of three-dimensional objects may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform a three-dimensional printability analysis of the model, calculate one or more corrections to the model designed to decrease the stresses associated with a respective test case, and evaluate the corrections, as described herein. Other embodiments of the printability improvement module may be at least partially implemented by hardware circuitry and/or firmware stored, for example, in a non-volatile memory.

### Example Implementations

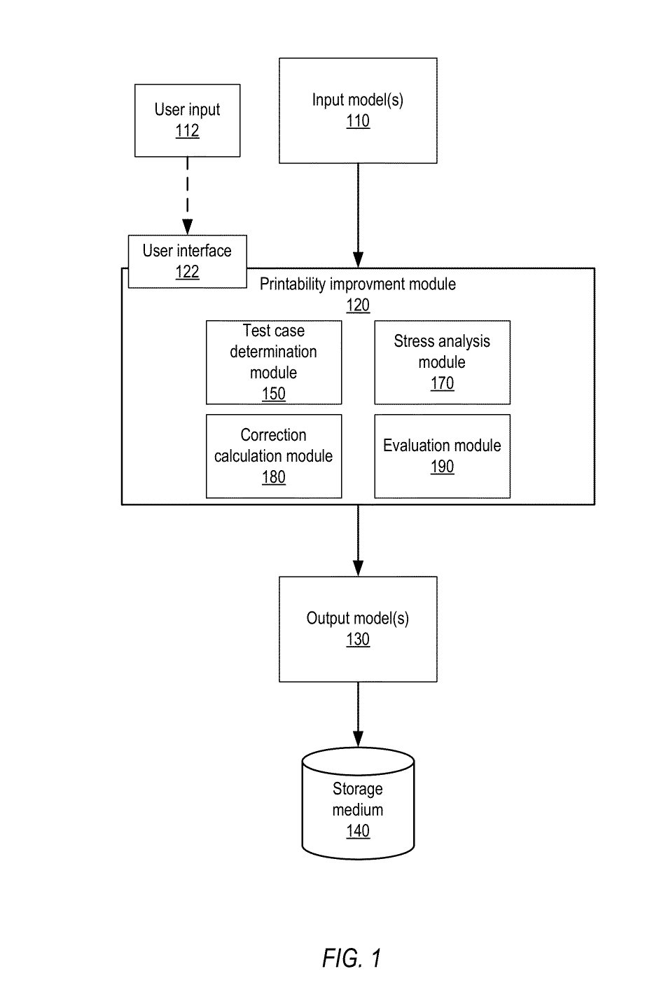

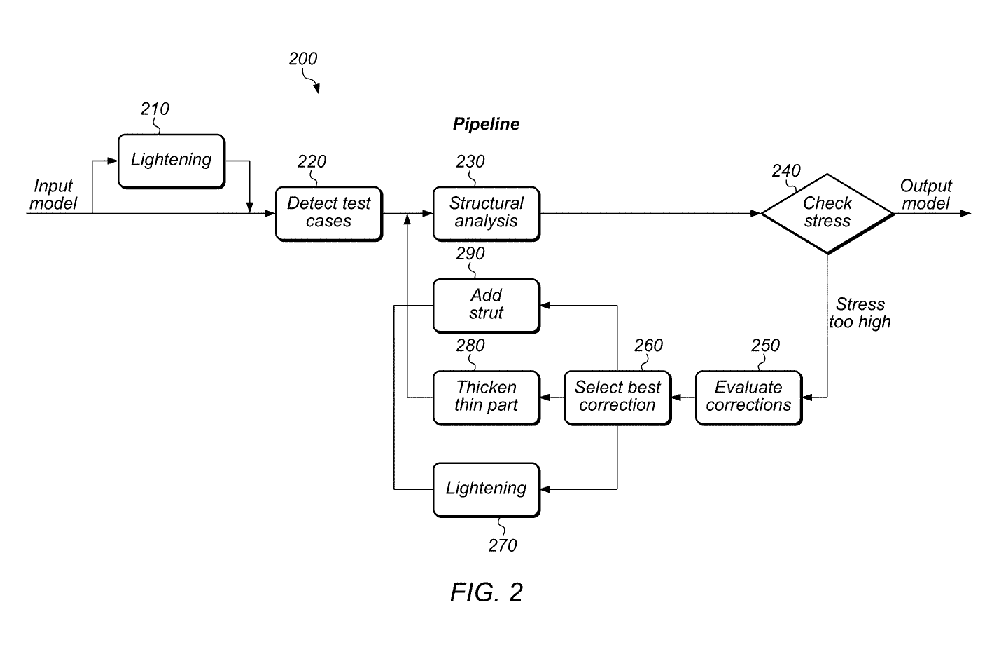

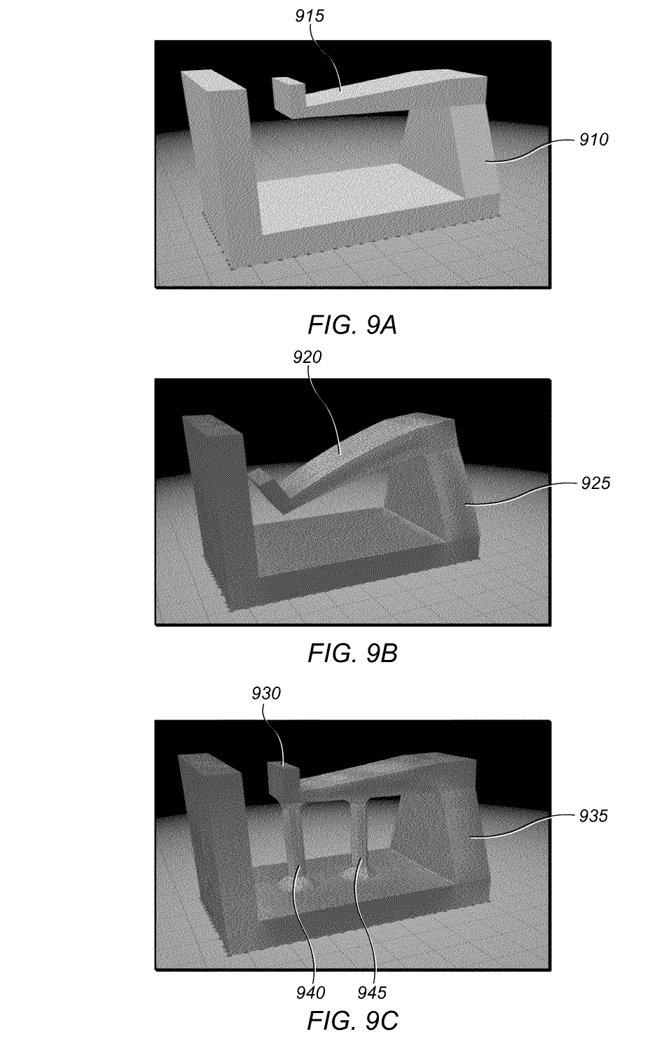

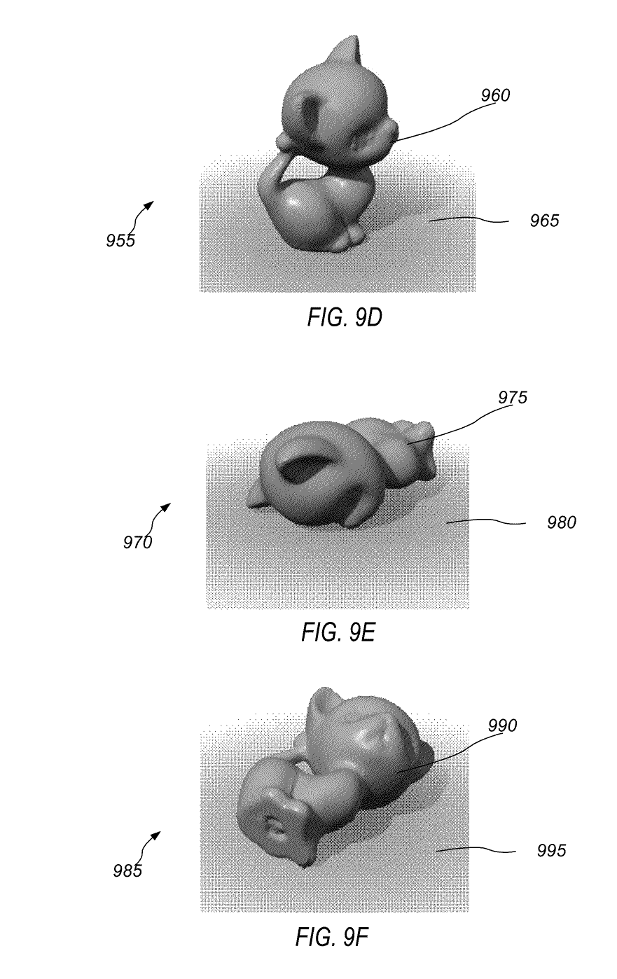

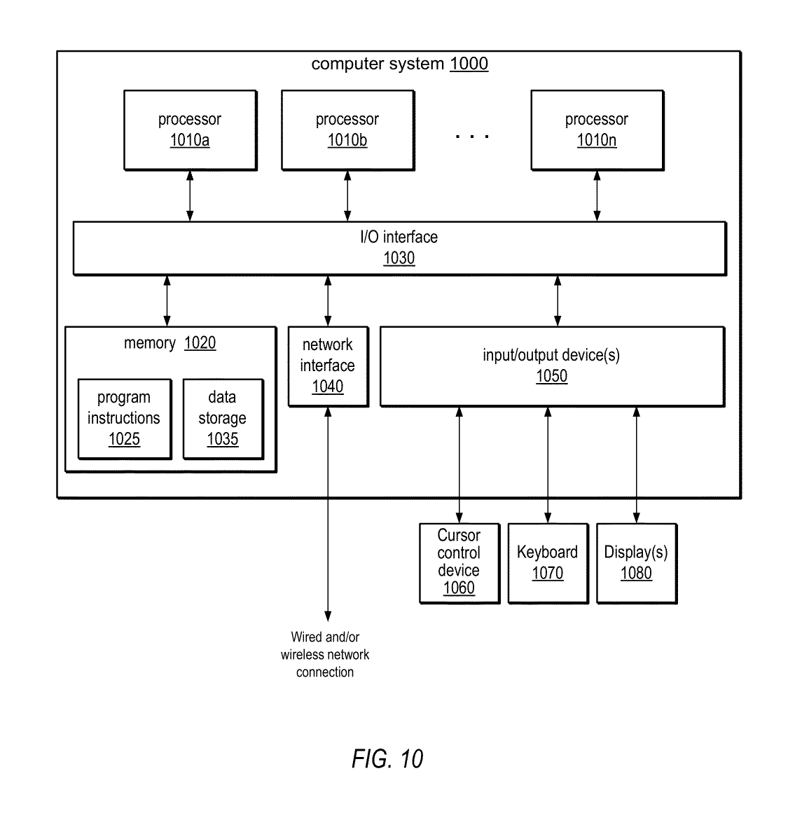

FIG. 1 illustrates a module that for improvement of printability of three-dimensional objects, according to some embodiments, which may implement one or more of the techniques and tools for improving printability of three-dimensional objects illustrated in FIGS. 2-9. Printability improvement module 120 may, for example, implement one or more of a printability improvement tool or a printability verification tool. FIG. 10 illustrates an example computer system on which embodiments of printability improvement module 120 may be implemented. Printability improvement module 120 receives as input one or more input models 110. An example input model is shown in FIG. 9A. Printability improvement module 120 may receive user input 112 activating a printability improvement tool or a printability verification tool. Printability improvement module 120 then edits the input models(s) 110. In some embodiments, such a process of editing a model includes performing a three-dimensional printability analysis of the model, calculating one or more corrections to the model designed to decrease stresses and evaluating the corrections, as described herein, according to user input 112 received via user interface 122. In some embodiments, the user may interact with printability improvement module 120 to specify parameters to be used in calculating corrections. Printability improvement module 120 generates as output one or more modified output models 130. Output models(s) 130 may, for example, be stored to a storage medium 140, such as system memory, a disk drive, DVD, CD, etc.

In some embodiments, printability improvement module 120 may provide a user interface 122 via which a user may interact with the printability improvement module 120, for example to activate a printability improvement model editing tool, to select a model for editing, to select parameters or select corrections, and to perform a printability improvement method as described herein. In some embodiments, the user interface may provide user interface elements whereby the user may select options including, but not limited to, the preference for particular types of corrections, weighting factors, and/or criteria for selecting corrections based on criteria.

In some embodiments, printability improvement module 120 includes a test case determination module 150 for determining the set of test cases for the model of the solid object to be generated by the automated manufacturing system. In some embodiments, each test case of the set of test cases represents an orientation of the solid object relative to a support, and the determining the set of test cases for the model of the solid object to be generated by the automated manufacturing system comprises detecting surfaces by which the solid object may receive force.

In some embodiments, printability improvement module 120 includes a stress analysis module 170 that generates one or more points at which stresses associated with the test case exceed the structural tolerances of a material to be used by the three-dimensional printing system for a fabrication of the model. In some embodiments, printability improvement module 120 includes a correction calculation module 180 for calculating one or more corrections to the model designed to decrease the stresses associated with a respective test case. In some embodiments, the one or more corrections from correction calculation module 180 include adding a supporting member to a component of the model.

In some embodiments, the one or more corrections from correction calculation module 180 include adjusting a thickness of a component of the model. In some embodiments, the one or more corrections comprise inserting a void into the model. In some embodiments, the one or more corrections from correction calculation module 180 include changing the material proposed for fabrication of the model. In some embodiments, correction calculation module 180 is configured such that the calculating the one or more corrections to the model designed to decrease the stresses associated with the test case further comprises selecting the one or more corrections based on user indicated preferences for particular types of corrections. In some embodiments, correction calculation module 180 is configured such that the calculating the one or more corrections to the model designed to decrease the stresses associated with the test case further comprises selecting the one or more corrections based on calculations of a scoring model comprising weights reflecting user indicated preferences for particular types of corrections.

In some embodiments, printability improvement module 120 includes an evaluation module 190 for evaluating the corrections. In some embodiments, the evaluating comprises selecting a preferred correction based on one or more criteria. In some embodiments, evaluation module 190 is configured such that the evaluating the corrections further comprises analyzing a change in material cost reflecting the corrections. In some embodiments, evaluation module 190 is configured such that the evaluating the corrections further comprises analyzing visibility of design changes resulting from the corrections. In some embodiments the evaluating the corrections comprises iterating the structural analysis of the model with the corrections to the model. In some embodiments, evaluation module 190 is configured such that the evaluating the corrections further comprises analyzing a net change of external model dimensions resulting from the corrections.

### Example Operations for Improving Printability of Solid Models

FIG. 2 depicts one embodiment of a high-level logical flowchart for a process to improve printability of three-dimensional objects. In some embodiments, an initial hollowing operation is performed (block 210). Test cases are then detected (block 220). A structural analysis is then performed (block 230). A determination is made to check stress as to whether one or more points exist at which stresses associated with the test case exceed the structural tolerances of a material to be used by the three-dimensional printing system for a fabrication of the model (block 240). If no such points exist, the model is output for printing. If such points exist, corrections are evaluated (block 250). Corrections are selected (block 260). One or more of hollowing (block 270), thickening a thin part (block 280) and adding a strut (block 290) is performed. The process then returns to block 230, which is described above.

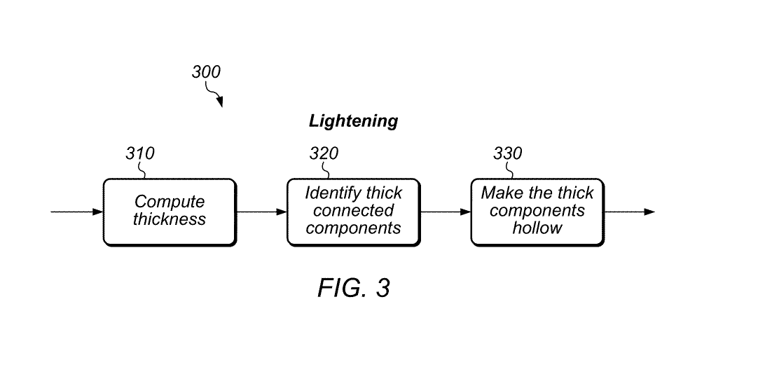

FIG. 3 illustrates one embodiment of a high-level logical flowchart for a hollowing operation to improve printability of three-dimensional objects, according to some embodiments. Thickness values are computed (block 310). Thick components are identified (block 320). Thick components are rendered hollow by the insertion of voids (block 330).

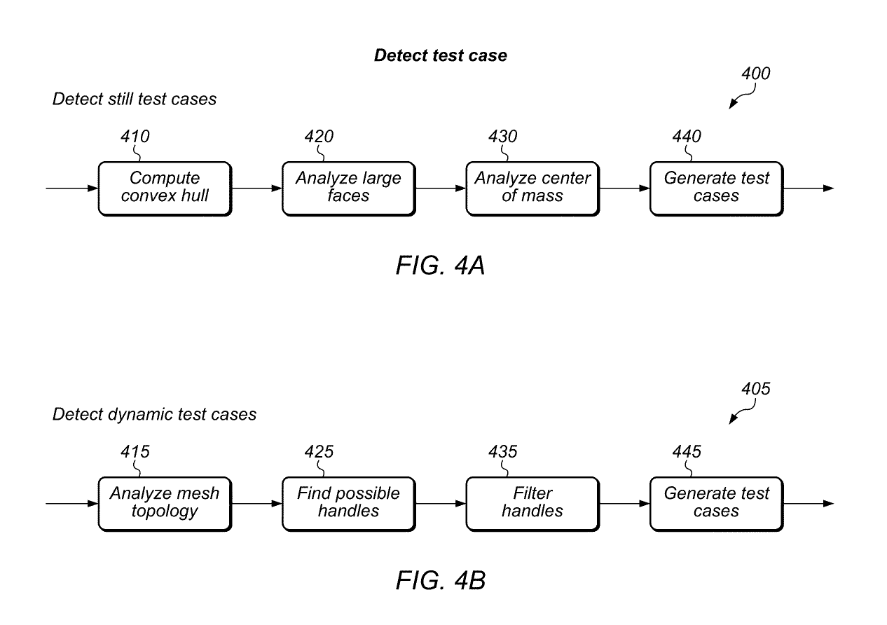

FIG. 4A depicts one embodiment of a high-level logical flowchart for a static test case detection operation to improve printability of three-dimensional objects, according to some embodiments. A convex hull is computed (block 410). Large faces of the model are analyzed (block 420). A center of mass is analyzed (block 430). Test cases are generated (block 440).

FIG. 4B illustrates one embodiment of a high-level logical flowchart for a dynamic test case detection operation to improve printability of three-dimensional objects, according to some embodiments. A mesh topology is analyzed (block 415). Possible handles are discovered (block 425). Handles are filtered (block 435). Test case are generated (block 445).

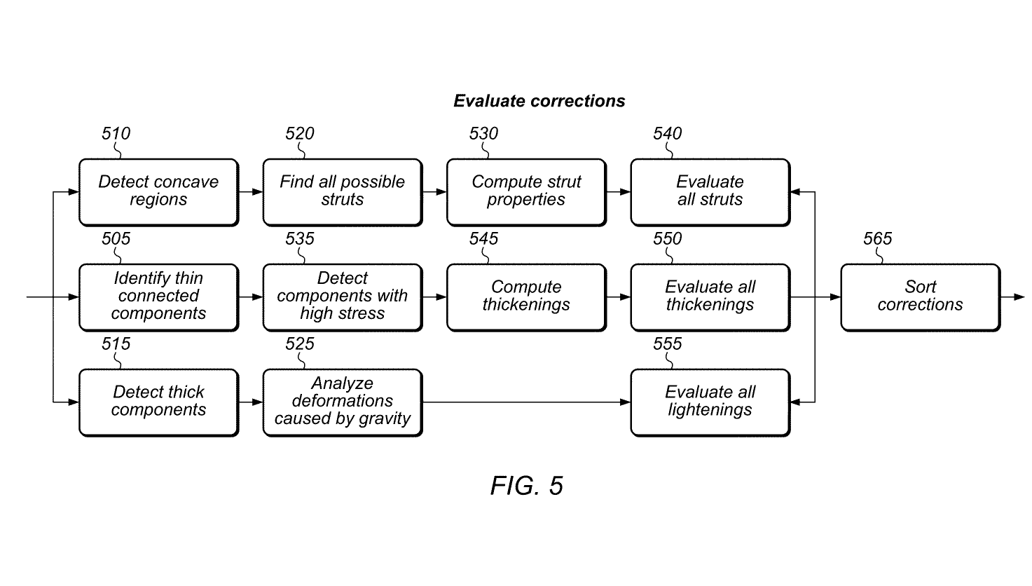

FIG. 5 depicts one embodiment of a high-level logical flowchart for a correction operation to improve printability of three-dimensional objects, according to some embodiments. Correction evaluation proceeds along three tracks. Along a first track, concave regions are detected (block 510). A set of possible struts is discovered (block 520). Strut properties are computed (block 530). Struts are evaluated (block 540). Along a second track, thin connected components are detected (block 505). Components with high stress are detected (block 535). Thickenings are computed (block 545). Thickenings are evaluated (block 550). Along a third track, thick components are detected (block 515). Deformations caused by gravity are analyzed (block 525). Hollowings are evaluated (block 525). Each of the three tracks then terminates in a connection sorting routine (block 565).

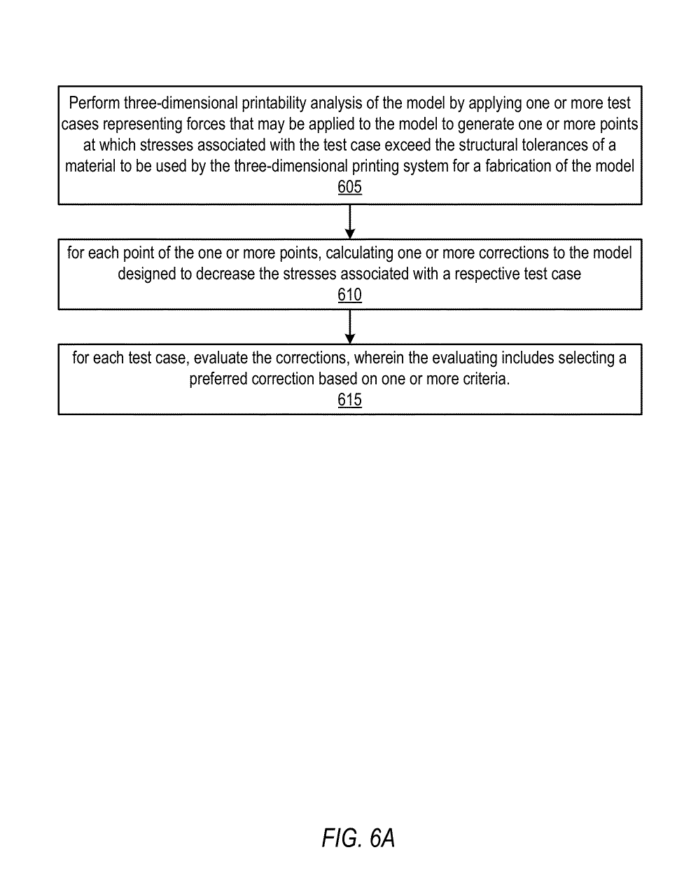

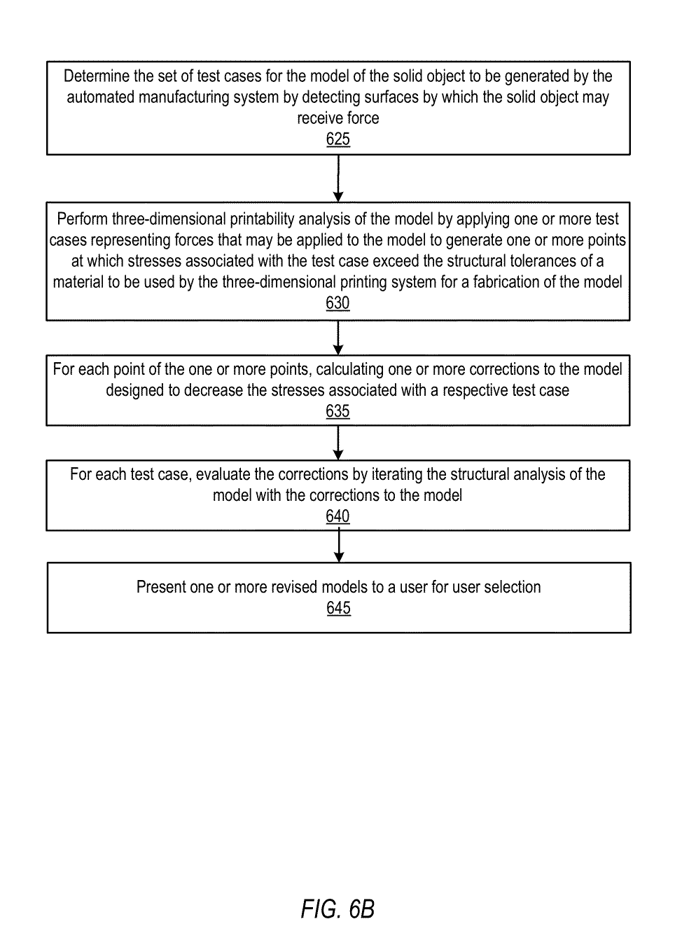

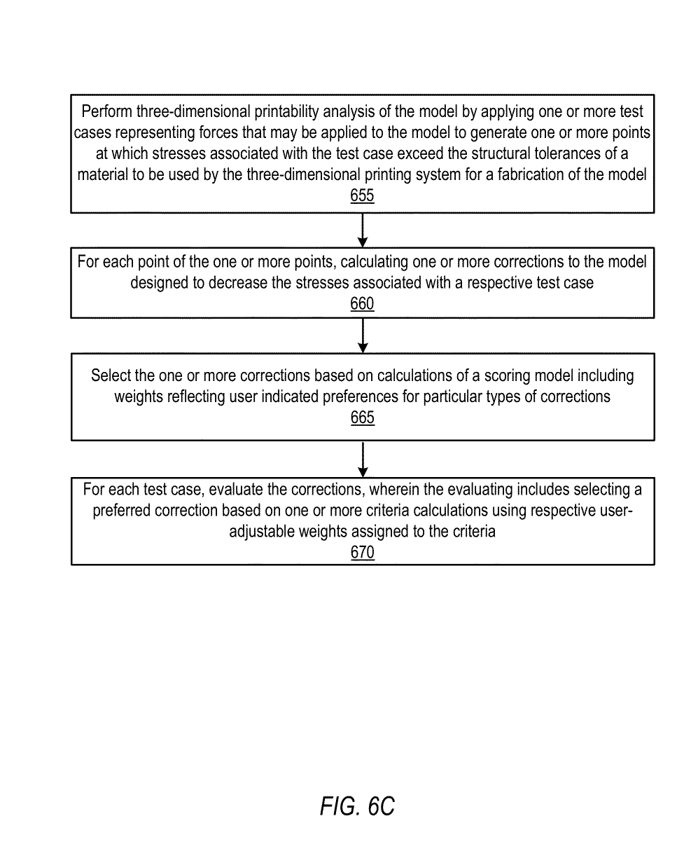

FIG. 6A illustrates one embodiment of a high-level logical flowchart for a process to improve printability of three-dimensional objects. Three-dimensional printability analysis of the model is performed by applying one or more test cases representing forces that may be applied to the model to generate one or more points at which stresses associated with the test case exceed the structural tolerances of a material to be used by the three-dimensional printing system for a fabrication of the model (block 605). For each point of the one or more points, one or more corrections to the model designed to decrease the stresses associated with a respective test case are calculated (block 610). For each test case, corrections are evaluated (block 615). In some embodiments, the evaluating comprises selecting a preferred correction based on one or more criteria

FIG. 6B depicts one embodiment of a high-level logical flowchart for a process to improve printability of three-dimensional objects. The set of test cases for the model of the solid object to be generated by the automated manufacturing system is determined by detecting surfaces by which the solid object may receive force (block 625). A three-dimensional printability analysis of the model is performed by applying one or more test cases representing forces that may be applied to the model to generate one or more points at which stresses associated with the test case exceed the structural tolerances of a material to be used by the three-dimensional printing system for a fabrication of the model (block 630). For each point of the one or more points, one or more corrections to the model designed to decrease the stresses associated with a respective test case are calculated (block 635). For each test case, the corrections are evaluated by iterating the structural analysis of the model with the corrections to the model (block 640). One or more revised models are presented to a user for user selection (block 645).

FIG. 6C illustrates one embodiment of a high-level logical flowchart for a process to improve printability of three-dimensional objects. Three-dimensional printability analysis of the model is performed by applying one or more test cases representing forces that may be applied to the model to generate one or more points at which stresses associated with the test case exceed the structural tolerances of a material to be used by the three-dimensional printing system for a fabrication of the model (block 655). For each point of the one or more points, one or more corrections to the model designed to decrease the stresses associated with a respective test case is calculated (block 660). The one or more corrections is selected based on calculations of a scoring model comprising weights reflecting user indicated preferences for particular types of corrections (block 665). For each test case, the corrections are evaluated, wherein the evaluating comprises selecting a preferred correction based on one or more criteria calculations using respective user-adjustable weights assigned to the criteria (block 670).

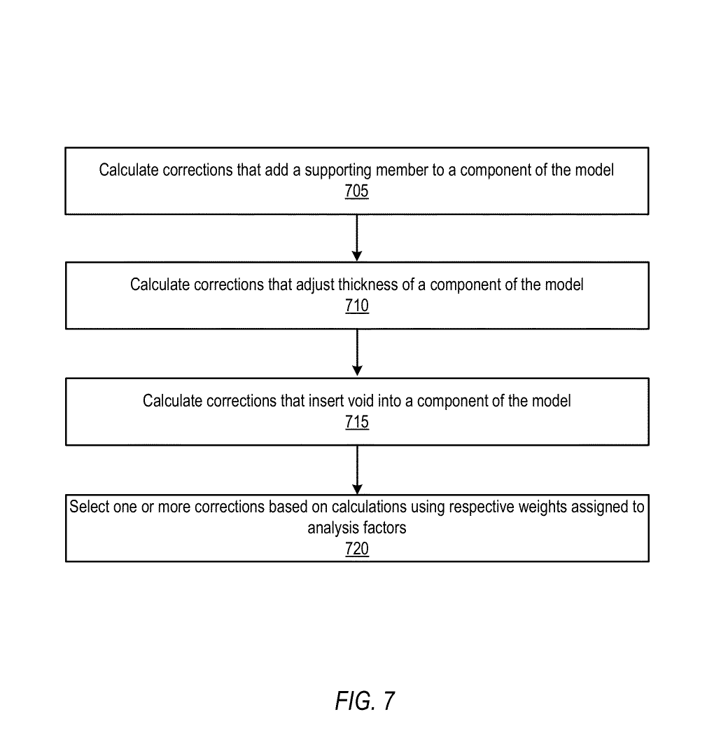

FIG. 7 depicts one embodiment of a high-level logical flowchart for a correction calculation operation to improve printability of three-dimensional objects, according to some embodiments. Corrections that add a supporting member to a component of the model are calculated (block 705). Corrections that adjust thickness of a component of the model are calculated (block 710). Corrections that insert a void into a component of the model are calculated (block 715). One or more corrections based on calculations using respective weights assigned to analysis factors are selected (block 720).

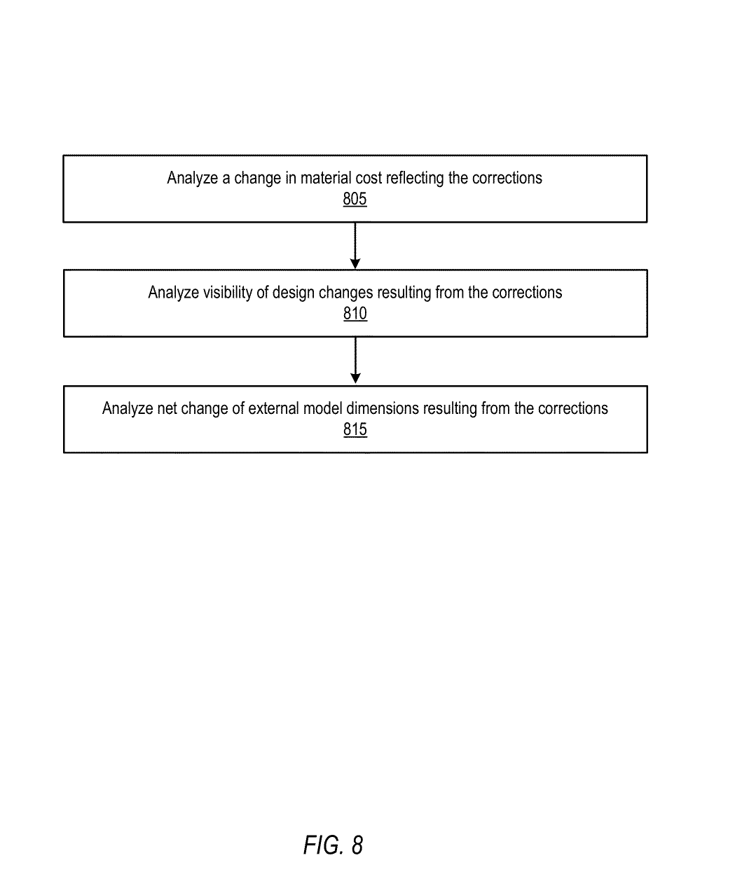

FIG. 8 illustrates one embodiment of a high-level logical flowchart for a correction analysis operation to improve printability of three-dimensional objects, according to some embodiments. Change in material cost reflecting the corrections is analyzed (block 805). Visibility of design changes resulting from the corrections is analyzed (block 810). Net change of external model dimensions resulting from the corrections is analyzed (block 815).

FIG. 9A depicts a model of a solid object that may be improved using a process to improve printability of three-dimensional objects, according to some embodiments. A solid model 910 with a cantilevered arm 915 is presented for analysis.

FIG. 9B illustrates a result of a stress analysis of a model of a solid object for use in a process to improve printability of three-dimensional objects, according to some embodiments. After stress analysis, it becomes apparent that solid model 925 will deform by allowing cantilevered arm 920 to fall under the force of gravity.

FIG. 9C depicts an improved model of a solid object resulting from a process to improve printability of three-dimensional objects, according to some embodiments. A correct model 935 is shown with cantilevered arm 930 supported by a first strut 940 and a second strut 945.

FIGS. 9D-9F illustrate test cases for a stress analysis of a model of a solid object for use in a process to improve printability of three-dimensional objects, according to some embodiments. FIG. 9D shows a simulated environment 955 with a model 960 sitting upright on a flat plane 965. FIG. 9E shows a simulated environment 970 with a model 975 sitting face down on a flat plane 980. FIG. 9F shows a simulated environment 985 with a model 980 sitting upright on a flat plane 995.

### Example System

Embodiments of a printability improvement module and/or of the various printability improvement model editing techniques as described herein may be executed on one or more computer systems, which may interact with various other devices. One such computer system is illustrated by FIG. 10 In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a printability improvement module are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1025, configured to implement embodiments of a printability improvement module as described herein, and data storage 1035, comprising various data accessible by program instructions 1025. In one embodiment, program instructions 1025 may include software elements of embodiments of a printability improvement module as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of a printability improvement module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A computer-implemented method, the method comprising:
for a computer-based three-dimensional model to be generated by a three-dimensional printing system, performing a three-dimensional printability analysis of the model, wherein
the three-dimensional printability analysis applies one or more test cases representing forces that may be applied to the model;
the three-dimensional printability analysis generates one or more points at which stresses associated with the test case exceed the structural tolerances of a material to be used by the three-dimensional printing system for a fabrication of the model;
for each point of the one or more points, calculating one or more corrections to the model designed to decrease the stresses associated with a respective test case; and
for each test case, evaluating the corrections, wherein the evaluating comprises selecting a preferred correction based on one or more criteria.

2. The computer implemented method of claim 1, wherein
the one or more corrections comprise adding a supporting member to a component of the model.

3. The computer implemented method of claim 1, wherein
the one or more corrections comprise adjusting a thickness of a component of the model.

4. The computer implemented method of claim 1, wherein
the one or more corrections comprise inserting a void into the model.

5. The computer implemented method of claim 1, wherein
the evaluating the corrections further comprises analyzing a change in material cost reflecting the corrections.

6. The computer implemented method of claim 1, wherein
the evaluating the corrections further comprises analyzing visibility of design changes resulting from the corrections.

7. The computer implemented method of claim 1, further comprising
presenting one or more revised models to a user, wherein the one or more revised models reflect at least one of the one or more corrections.

8. A non-transitory computer-readable storage medium storing program instructions, wherein the program instructions are computer-executable to implement:
for a computer-based three-dimensional model to be generated by a three-dimensional printing system, performing a three-dimensional printability analysis of the model, wherein
the program instructions computer-executable to implement the three-dimensional printability analysis further comprise program instructions computer-executable to implement applying one or more test cases representing forces that may be applied to the model;
the program instructions computer-executable to implement the three-dimensional printability analysis further comprise program instructions computer-executable to implement generating one or more points at which stresses associated with the test case exceed the structural tolerances of a material to be used by the three-dimensional printing system for a fabrication of the model;
for each point of the one or more points, calculating one or more corrections to the model designed to decrease the stresses associated with a respective test case; and
for each test case, evaluating the corrections, wherein the program instructions computer-executable to implement the evaluating comprise program instructions computer-executable to implement selecting a preferred correction based on one or more criteria.

9. The non-transitory computer-readable storage medium of claim 8, wherein
the program instructions computer-executable to implement the calculating the one or more corrections to the model designed to decrease the stresses associated with the test case further comprise program instructions computer-executable to implement
selecting the one or more corrections based on calculations using respective weights assigned to
changes in material cost resulting from respective ones of the one or more corrections, and
visibility of design changes resulting from the one or more corrections.

10. The non-transitory computer-readable storage medium of claim 8, wherein
the program instructions computer-executable to implement the calculating the one or more corrections to the model designed to decrease the stresses associated with the test case further comprise program instructions computer-executable to implement
selecting the one or more corrections based on calculations using respective user-adjustable weights assigned to
changes in material cost resulting from respective ones of the one or more corrections, and
visibility of design changes resulting from the one or more corrections.

11. The non-transitory computer-readable storage medium of claim 8, wherein
the one or more corrections comprise changing the material proposed for fabrication of the model.

12. The non-transitory computer-readable storage medium of claim 8, wherein
the program instructions computer-executable to implement the calculating the one or more corrections to the model designed to decrease the stresses associated with the test case further comprise program instructions computer-executable to implement
selecting the one or more corrections based on user indicated preferences for particular types of corrections.

13. The non-transitory computer-readable storage medium of claim 8, wherein
the program instructions computer-executable to implement the calculating the one or more corrections to the model designed to decrease the stresses associated with the test case further comprise program instructions computer-executable to implement
selecting the one or more corrections based on calculations of a scoring model comprising weights reflecting user indicated preferences for particular types of corrections.

14. A system, comprising:
at least one processor; and
a memory comprising program instructions, wherein the program instructions are executable by the at least one processor to:
for a computer-based three-dimensional model to be generated by a three-dimensional printing system, perform a three-dimensional printability analysis of the model, wherein
the three-dimensional printability analysis applies one or more test cases representing forces that may be applied to the model;
the three-dimensional printability analysis generates one or more points at which stresses associated with the test case exceed the structural tolerances of a material to be used by the three-dimensional printing system for a fabrication of the model;
for each point of the one or more points, calculate one or more corrections to the model designed to decrease the stresses associated with a respective test case; and
for each test case, evaluate the corrections, wherein the program instructions executable by the at least one processor to evaluating comprises program instructions executable by the at least one processor to select a preferred correction based on one or more criteria.

15. The system of claim 14, further comprising
program instructions executable by the at least one processor to determine the set of test cases for the model of the solid object to be generated by the automated manufacturing system, wherein
each test case of the set of test cases represents an orientation of the solid object relative to a support;

16. The system of claim 15, wherein
program instructions executable by the at least one processor to determine the set of test cases for the model of the solid object to be generated by the automated manufacturing system comprises program instructions executable by the at least one processor to detect surfaces by which the solid object may receive force.

17. The computer implemented method of claim 16, wherein
program instructions executable by the at least one processor to evaluate the corrections comprise program instructions executable by the at least one processor to iterate the structural analysis of the model with the corrections to the model.

18. The system of claim 14, wherein
program instructions executable by the at least one processor to evaluate the corrections further comprise program instructions executable by the at least one processor to analyze a net change of external model dimensions resulting from the corrections.

19. The system of claim 14, wherein
the one or more corrections comprise adjusting a thickness of a component of the model.

20. The system of claim 14, wherein
the one or more corrections comprise inserting a void into the model.
